(19) United States
(12) Patent Application Publication
(10) Pub. No.: US 2006/0267568 A1
(43) Pub. Date: Nov. 30, 2006

(54) Voltage regulating circuit and method thereof

(75) Inventor: Chao-Sheng Huang, Taipei Hsien (TW)

Correspondence Address: BIRCH STEWART KOLASCH & BIRCH, PO BOX 747, FALLS CHURCH, VA, 22040-0747, US

(73) Assignee: VIA TECHNOLOGIES, INC.

(21) Appl. No.: 11/439,986

(22) Filed: May 25, 2006

(30) Foreign Application Priority Data
May 27, 2005 (TW) 94117433

(51) Int. Cl. G05F 3/20

(52) U.S. Cl. 323/316

(57) ABSTRACT

A voltage regulator and regulating method thereof are provided for providing a stable output voltage. The voltage regulating circuit includes an operational amplifier having a positive input terminal, a negative input terminal and an output terminal, wherein said negative input terminal is connected to a reference voltage; a current mirror having a reference terminal and a mirror terminal; and a first transistor having a gate connected to the output terminal of the operational amplifier, a source connected to the reference terminal of the current mirror, and a drain connected to the positive input terminal of the operational amplifier.

### FIELD OF THE INVENTION

The present invention relates to a regulating circuit, more particularly to a voltage regulator circuit for regulating the output voltage.

### BACKGROUND OF THE INVENTION

A voltage regulator generally includes an operational amplifier that is adapted to produce an output voltage source based on a reference voltage.

### SUMMARY OF THE INVENTION

The present invention provides a voltage regulator and regulating method thereof for providing a stable output voltage.

The present invention provides a voltage regulating circuit for regulating an output voltage. The circuit includes an operational amplifier having a positive input terminal, a negative input terminal and an output terminal, wherein said negative input terminal is connected to a reference voltage; a current mirror having a reference terminal and a mirror terminal; and a first transistor having a gate connected to the output terminal of the operational amplifier, a source connected to the reference terminal of the current mirror, and a drain connected to the positive input terminal of the operational amplifier.

The present invention also provides a method for regulating a output voltage of a voltage regulator circuit having a current mirror, a first transistor and a second transistor, wherein the current mirror having as least two transistors. The method includes: adjusting a mirror current by varying the channel ratios of the transistors in the current mirror; and adjusting the output voltage of the voltage regulator circuit by varying the resistances of the first resistor and the second resistor.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 illustrates a conventional voltage regulator circuit;

FIG. 2 illustrates a conventional voltage regulator circuit; and

FIG. 3 shows a voltage regulator circuit of the present invention.

### DETAILED DESCRIPTIONS OF THE PREFERRED EMBODIMENT

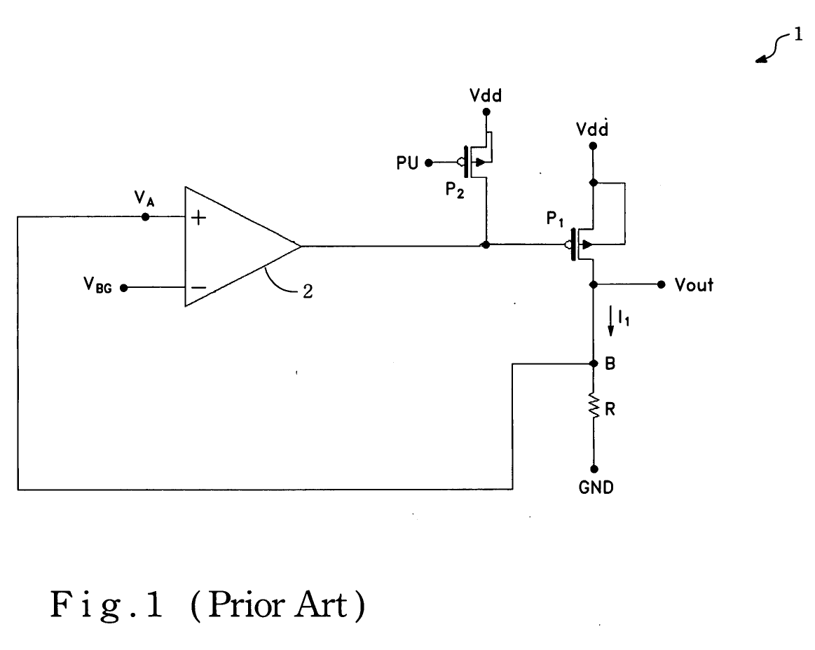

FIG. 1 illustrates a conventional voltage regulator circuit 1, which includes an operational amplifier 2, a first PMOS transistor P₁, a second PMOS transistor P₂ and a resistor R. The operational amplifier 2 has an output terminal connected to a gate of the first PMOS transistor P₁, a negative input terminal connected to a reference voltage V_{BG}, and a positive input terminal connected to the node B of the resistor R. The second PMOS transistor P₂ has a drain connected to the output terminal of the operational amplifier 2 and the gate of the first PMOS transistor P₁. The first PMOS transistor P₁ has a source connected to a voltage source V_{dd} and a drain connected to the resistor R through node B. The second PMOS transistor P₂ resets the voltage regulator.

Upon receipt of the reference voltage V_{BG} at the negative input terminal of the operational amplifier 2, the voltage V_{A} at the positive input terminal is pulled up to the reference voltage V_{BG}, and thereby pulling down the output voltage and a voltage difference with respect to the voltage source V_{dd} such that the first PMOS transistor P₁ is switched on and a current I₁ flows, wherein the output voltage V_{OUT}=I₁×R . Since the output voltage V_{OUT} is equal to the voltage applied to the positive input terminal V_{A} of the operational amplifier 2, and V_{BG}=V_{A}, the output voltage Vₒᵤₜ is the same as the reference voltage V_{BG}.

In this circuit, the MOS transistors with fixed band gap provides the reference voltage V_{BG} and a stable current flowing through the MOS transistor, but the disadvantage is the current is not large. A MOS transistor with larger dimension can provides a larger current flowing at the output terminal. In addition, the operational amplifier 2 serves as a unit gain buffer in this circuit for comparing the reference voltage V_{BG} and the voltage of the positive input terminal V_{A} so as to result in the output voltage V_{OUT}. However, the limitation of the output voltage is V_{BG}=V_{OUT}.

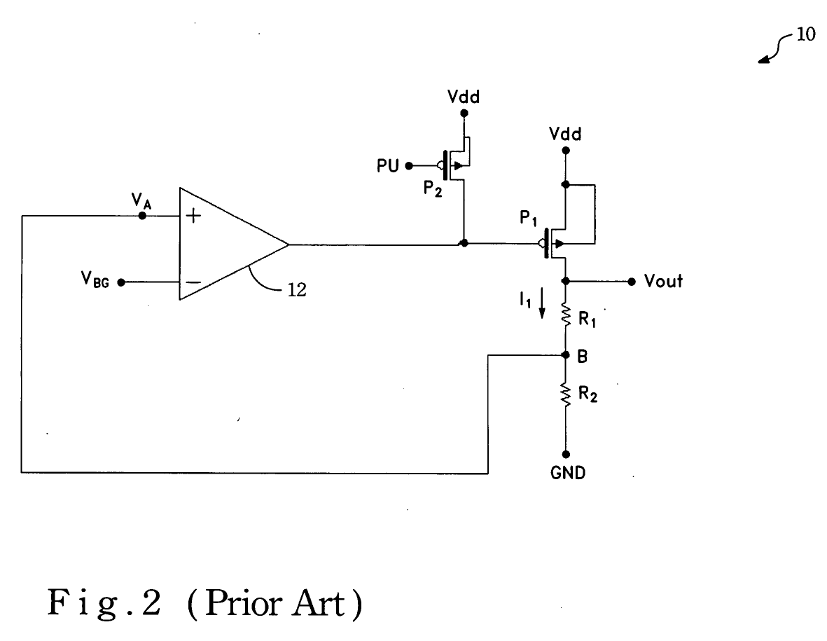

FIG. 2 illustrates another conventional power regulator circuit 10, and includes an operational amplifier 12, a first PMOS transistor P₁, a second PMOS transistor P₂ and two resistor R₁, R₂. The amplifier 12 has an output terminal connected to a gate of the first PMOS P₁, a negative input terminal connected to a reference voltage V_{BG}, and a positive input terminal connected to the resistors R₁, R₂ through the node B. The second PMOS transistor P₂ has a drain connected to the output terminal of the operational amplifier 12 and the gate of the first PMOS transistor P₁, wherein the gate of the first PMOS transistor P₁ is further connected to the output terminal of the operational amplifier 12. The first PMOS transistor P₁ further has a source connected in series to the resistors R₁, R₂ and the ground terminal GND. The resistors R₁, R₂ are further coupled to the positive input terminal of the operational amplifier 12 through the node B.

Upon receipt of the reference voltage V_{BG} at the negative input terminal of the operational amplifier 12, the voltage V_{A} at the positive input terminal is pulled up to the reference voltage V_{BG}, and thereby the output voltage is pulled down to approximately zero. Such that the first PMOS transistor P₁ is switched on and a current I₁ flows, wherein the output voltage V_{OUT}=I₁×(R₁+R₂). Since the voltage V_{B} (at node B between the resistors R₁, R₂)=I₁×R₂=V_{A}, and V_{A}=V_{BG}; as a result, V_{A}=V_{BG}=I₁×R₂, and I₁=V_{BG}/R₂, therefore the output voltage V_{OUT}=I₁×(R₁+R₂)=V_{BG}×(R₁+R₂)/R₂.

In the above circuit, the resistance of the resistors R₁, R₂ are regulated to produce the output voltage V_{OUT}, therefore the limitation of the output voltage (V_{BG}=V_{OUT}) is solved. However, in order to achieve a preferable and precise ratio of the resistors R₁, R₂, the resistors R₁, R₂ are generally made of polysilicon material so that the resistors R₁, R₂ may be several thousands ohms. Thus, the resistor R₁ forms a heavy load within the negative loop circuit so as to lower gain, and thereby to cause system failure under certain circumstances. Further, the system is more aggravated and unstable since the output terminal is coupled to several different circuits.

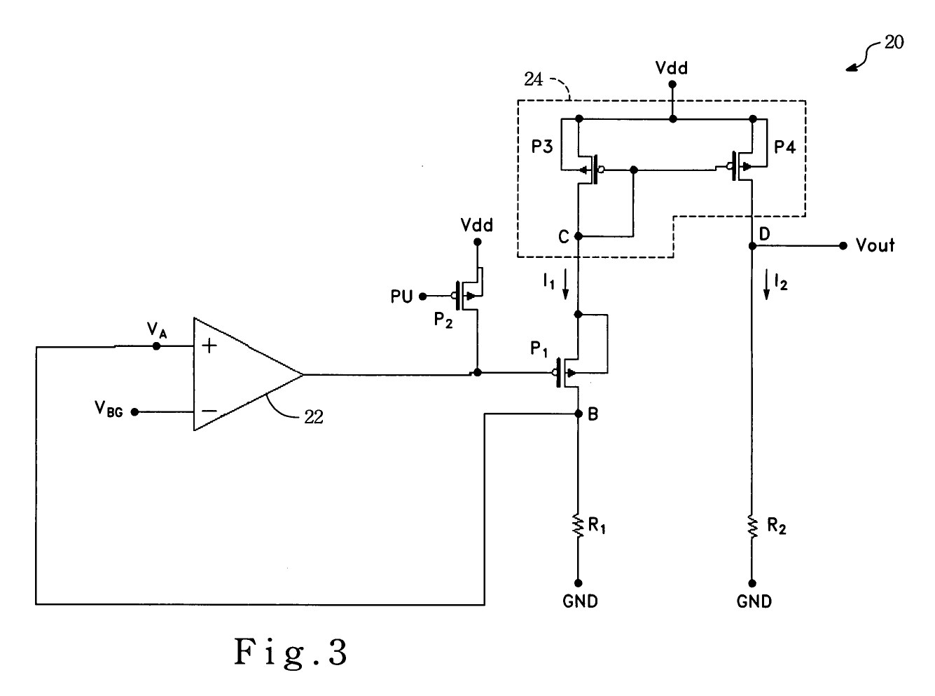

FIG. 3 is a voltage regulator circuit in accordance with the present invention. The voltage regulator 20 includes a current mirror 24, an operational amplifier 22, a first resister R₁, a second resister R₂, a first PMOS transistor P₁, and a second PMOS transistor P₂. The current mirror 24 has a reference terminal connected to the first PMOS transistor P₁, the resistor R₁, and a ground terminal GND in series; and a mirror terminal connected to the second resistor R₂ and the ground terminal GND in series. The current mirror 24 is made of a third and a fourth PMOS transistors P₃, P₄ which gates are connected together and sources coupled to a voltage source V_{dd} respectively. The third PMOS transistor P₃ has a drain connected to the source of the first PMOS transistor P₁, while the gate of the third PMOS transistor P₃ is coupled to the drain of itself and the source of the first PMOS transistor P₁ at node C. The drain of the fourth PMOS transistor P₄ is connected to the second resistor R₂ and the ground terminal GND in series, and an output terminal of the voltage regulator 20 is connected to the drain of the fourth PMOS transistor P₄ and the second resistor R₂ through a node D.

The operational amplifier 22 has a negative input terminal connected to a reference voltage V_{BG}, a positive input terminal connected to the first resistor R₁ and the drain of the first PMOS transistor P₁, and an output terminal connected to the gate of the first PMOS transistor P₁ and the drain of the second PMOS transistor P₂. An output signal of the operational amplifier 22 is used to drive the first PMOS transistor P₁. The drain of the second PMOS transistor P₂ is connected to the gate of the first PMOS transistor P₁. The second PMOS P₁₂ resets the voltage regulator circuit 20.

The operational amplifier 22 compares the reference voltage V_{BG} and the voltage V_{A} (voltage drop of the first resistor R₁), then the voltage V_{A} is pulled up to the reference voltage V_{BG}, and thereby the output voltage V_{OUT} is pulled down to cause a voltage difference with respect to the voltage source V_{dd}. Such that the first PMOS transistor P₁ is switched on, and a reference current I₁ of the current mirror 24 flows, wherein the voltage V_{B} of the node B is V_{B}=I₁×R₁=V_{A}. Since the voltage V_{A} is equal to the reference voltage V_{BG}, therefore, V_{BG}=V_{A}=I₁×R₁, I₁=V_{BG}/R₁. The reference current I₁ is the same as the current of third PMOS transistor P₃. The fourth PMOS transistor P₄ is switched on and a mirror current of the current mirror 24 flows. The mirrored current I₂ is proportioned to the reference current I₁, and therefore I₂=I₁×(W/L)_{P4}/(W/L)_{P3}. The W/L is the channel ratio of width-to-length of the channel in a transistor. The mirrored current I₂ is amplified by varying the width-to-length ratio of the PMOS transistors P₃·P₄, and determines the output voltage of the voltage regulator.

The output terminal of the voltage regulator 20 is connected to the mirror terminal and the second resistor R₂ through the node D, so that the output voltage V_{OUT} is the voltage drop of the resistor R₂. Therefore the output voltage V_{OUT} is determined by the resistors R₂ and the current I₂. thereby the output voltage V_{OUT}=I₂×R₂=I₁×(W/L)_{P4}/(W/L)_{P3}×R₂=V_{BG}×(R₂*(W/L)_{P4}/R₁*(W/L)_{P3}). Thus, the output voltage V_{OUT} can be bigger or smaller than the reference voltage V_{BG} by adjusting the channel ratio of width and length (W/L) of the PMOS transistors P₃·P₄ so as to adjust the mirrored current I₂. Otherwise, the output voltage V_{OUT} is also adjusted by regulating the resistors R₁, R₂.

The power regulator circuit in the present invention has many improvements.
a. In the conventional voltage regulator, the output terminal coupled to several different circuits and the operation amplifier which is heavy loaded within the negative loop circuit and cause the lower gain and circuit unstable. However, in the present invention, a current mirror is added, the output terminal and the resistor R₂ are connected to the mirror terminal in series. Therefore the output voltage V_{OUT} is determined by adjusting the ratio of the resistors R₁, R₂. Furthermore, the output terminal and the resistor R₂ is connected to the current mirror which makes no connecting relationship to the negative loop circuit made from the operation amplifier. Thus the gain of the loop circuit will not be influenced.
b. Since the mirrored current I₂ is adjustable by varying the channel ratio of the PMOS transistors P₃·P₄ in the current mirror, the output voltage is also adjustable and stable.

Although the present invention and its advantages have been described in detail, as well as some variations over the disclosed embodiments, it should be understood that various other changes, substitutions and alterations can be made herein without departing from the spirit and scope of the invention as defined by the appended claims.

I claim:

1. A voltage regulating circuit for regulating an output voltage, comprising:
an operational amplifier comprising a positive input terminal, a negative input terminal and an output terminal, wherein said negative input terminal is connected to a reference voltage;
a current mirror comprising a reference terminal and a mirror terminal; and
a first transistor comprising a gate connected to the output terminal of the operational amplifier, a source connected to the reference terminal of the current mirror, and a drain connected to the positive input terminal of the operational amplifier.

2. The voltage regulating circuit according to claim 1, further comprising a second transistor comprising a source connected to a voltage source, and a drain connected to the output terminal of the operational amplifier and the gate of the first transistor for resetting the voltage regulator circuit.

3. The voltage regulating circuit according to claim 2, wherein the first and the second transistors are PMOSs.

4. The voltage regulating circuit according to claim 1, wherein the current mirror comprises: a third transistor and a fourth transistor, the gates of the third transistor and the fourth transistor are connected together, the sources are connected to a voltage source respectively, a drain of the third transistor connected to the source of the second transistor, and the gate of the third transistor is connected to the drain of the third transistor.

5. The voltage regulating circuit according to claim 4, wherein each the third and the fourth transistors respectively has a channel ratio of width and length, wherein the output voltage is determined by varying the channel ratios of the third and the fourth transistors.

6. The voltage regulating circuit according to claim 4, further comprising: a first resistor connected between the drain of the first transistor and a ground terminal, and a second resistor connected between the drain of the fourth transistor and the ground terminal.

7. The voltage regulating circuit according to claim 4, wherein the output voltage is determined by varying the resistances of the first resistor and the second resistor.

8. The voltage regulating circuit according to claim 4, wherein the third and the fourth transistors are PMOSs.

9. A power regulator for regulating an output voltage, comprising:
an operational amplifier comprising a positive input terminal, a negative input terminal and an output terminal, wherein said negative input terminal is coupled to a reference voltage;
a current mirror comprising a reference terminal and a mirror terminal, wherein the current mirror has a reference current and a mirror current;
a first transistor comprising a gate connected to the output terminal of the operational amplifier, a source connected to the reference terminal of the current mirror, and a drain connected to the positive input terminal of the operational amplifier;
a first resistor connected between the drain of the first transistor and a ground terminal; and
a second resistor connected between the mirror terminal of the current mirror and the ground terminal.

10. The power regulator according to claim 9, further comprising a second transistor having a source coupled to a voltage source and a drain connected to the positive input terminal of the operational amplifier and the gate of the first transistor for resetting the power regulator.

11. The power regulator according to claim 9, wherein the current mirror comprises a third and a fourth transistors, the gates of the third and the fourth transistors are connected together; the sources of the third and the fourth transistors are connected to a voltage source respectively; the third transistor has a drain connected to the source of the second transistor; the gate of the third transistor is connected to the drain of the third transistor; the fourth transistor having a drain connected to the second resistor.

12. The power regulator according to claim 11, wherein the third and the fourth transistors are PMOSs.

13. The power regulator according to claim 11, wherein each the third and the fourth transistor respectively has a channel ratio of width and length, wherein the output voltage is determined by varying the channel ratios of the third and the fourth transistors.

14. The power regulator according to claim 9, wherein the output voltage is determined by varying the resistances of the first resistor and the second resistor.

15. The power regulator according to claim 9, wherein the first and the second transistors are PMOSs.

16. The power regulator according to claim 9, wherein an output voltage is determined by varying resistances of the first and the second resistors.

17. A method for regulating a output voltage of a voltage regulator circuit having a current mirror, a first transistor and a second transistor, wherein the current mirror having as least two transistors, the method comprising:
adjusting a mirror current by varying the channel ratios of the transistors of the current mirror; and
adjusting the output voltage of the voltage regulator circuit by varying the resistances of the first resistor and the second resistor.

18. The method of claim 17, wherein the output voltage is determined by the mirror current and the second resistor.
